(19) United States
(12) Patent Application Publication
(10) Pub. No.: US 2018/0165650 A1
(43) Pub. Date: Jun. 14, 2018

(54) INDEXING, TAGGING AND VIDEO INTERVIEWING PLATFORM WITH INTERVIEWER'S NETWORK

(71) Applicants: Abhijeet Arun KASHYAPE, Pune (IN); Ashutosh Arun KULKARNI, Pune (IN); Prafulla Purushottam PARASKAR, Pune (IN)

(72) Inventors: Abhijeet Arun KASHYAPE, Pune (IN); Ashutosh Arun KULKARNI, Pune (IN); Prafulla Purushottam PARASKAR, Pune (IN)

(21) Appl. No.: 15/574,888

(22) PCT Filed: May 18, 2016
(86) PCT No.: PCT/IN2016/050145

§ 371 Date: Nov. 17, 2017

(30) Foreign Application Priority Data
May 18, 2015 (IN) 1950/MUM/2015

(51) Int. Cl. G06Q 10/10; G06Q 10/06; H04N 7/15; G06F 17/30

(52) U.S. Cl. CPC G06Q 10/1053; G06Q 10/063112; G06F 17/30867; H04N 7/155; G06Q 10/1095

(57) ABSTRACT

The present invention relates to an indexing, tagging and video interviewing platform for online interaction of at least two people by matching their interests. The system includes a plurality of engines such as a primary assessment engine, a matching engine, a scheduling engine and a video interviewing engine. The engines work sequentially using a plurality of severs such as a web server, a notification server, a video conference server, a recording server, and a video post processing server. The mobile or desktop users may access the system via native app or browser available on the respective operating system or via installed web browser, the operating system supported with a hardware access such as a camera and a microphone.

### FIELD OF THE INVENTION

The present invention relates to an interviewing system and more particularly to a web-based platform for online interaction and recording video interviews.

### BACKGROUND OF THE INVENTION

Interviewing is a standard process of qualitative analysis for evaluating a person. The challenge in interviewing is to judge the interviewee in short time allotted for the interview. Interviews can be carried out in person or by telephonic means or by audio-visual means. It is understood here that the person who conducts the interview is not always the one having decision authority for the final judgment.

Interviews are conducted for various purposes such as for hiring employees for job or internships, for finding right candidate for performing desired task, for admitting students for preferred course and the like. Different examination processes can be carried out for short listing, however, final evaluation and judgment is always based on the interviews conducted by the experts. Selection of the right person involves evaluation of various credentials of the person being interviewed by the experts. In general, it is difficult for any person to express his technical, professional and personal skills to the interviewer unless specific questions on such skills are asked by the interviewer. Similarly, it is difficult for the interviewers to evaluate or explore the skills of the person being interviewed unless such skills are explored by the person interviewing the candidate in person. Hence, it is always a tedious task to match time and availability of two parties for conducting interviews for necessary purpose. Also, there is always a possibility of missing some important points during discussion.

The most common way to eliminate above stated problems is audio-visual recording of the interviews. The prior art discloses such video interviewing systems. These systems are used for conducting on-line interviews and recording the same for evaluation by experts. For example, United States patent application No. US20140236850A1 discloses a system for web-based interactive video interviewing. The system includes building interview set by customer, conducting interviews and evaluating recorded answers. It also carries out necessary follow up and generation of the interview report.

However, these prior art systems fail to intimate or guide the interviewer during discussion about technical, professional and personal skills of the person being interviewed. Moreover, these systems do not facilitate indication or tagging and classifying important points being discussed during the interaction. These prior art audio-visual interviewing is systems do not overcome the difficulty of missing some important points during discussion and/or facilitates selective playback of the important sections of the recording.

Accordingly, there is need of a system for conducting interviews and keeping record of the conducted interviews by audio-visual means thereby having a provision for highlighting sections of interest which gives better understanding of the interaction in a short time.

### SUMMARY OF THE INVENTION

The present invention relates to an indexing, tagging and video interviewing platform having an inbuilt network for online interaction of at least two people by matching their interests. The system includes a plurality of engines such as a primary assessment engine, a matching engine, a scheduling engine and a video interviewing engine. The engines work sequentially using a plurality of severs such as a web server, a notification server, a video conference server, a recording server, and a video post processing server. The web server provides access to the various functionalities such as profile data entry, scheduling of interviews, conducting interviews, watching the interview video files online among others to authenticated users. The system includes a plurality of databases such as a database and a video storage database. The system facilitates tagging, indexing and rating of an audio visual interview in addition to recording/playback and storage thereof on the databases. The mobile users may access the web server via native app or browser available on the respective operating system and the desktop users may connect to the web server via installed web browser, and the operating system with a browser supporting WebRTC and hardware access to camera and microphone is supported.

### BRIEF DESCRIPTION OF THE DRAWINGS

FIG. 1 is a schematic block diagram of an indexing, tagging and video interviewing platform of the present invention;

FIG. 2 is a schematic block diagram of an indexing, tagging and video interviewing platform of the present invention;

FIG. 3 is a flow chart for primary assessment and interview scheduling of the web based video interviewing system of FIG. 1;

FIG. 4 is a flow chart for post processing of tagged videos of the web based video interviewing system of FIG. 1; and

FIG. 5 is a schematic block diagram of a third user's interaction with the system in accordance with the present invention.

### DETAILED DESCRIPTION OF THE DRAWINGS

Although specific terms are used in the following description for sake of clarity, these terms are intended to refer only to particular structure of the invention selected for illustration in the drawings, and are not intended to define or limit the scope of the invention.

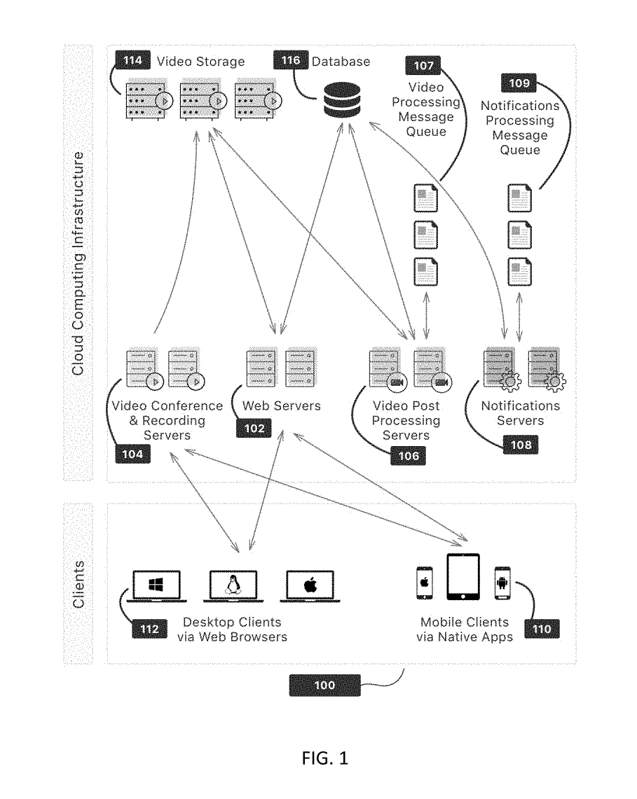

Referring to FIG. 1, a schematic block diagram of a web based video interviewing system 100 is shown. The system 100 comprises a plurality of servers such as at least one web server 102, at least one video conferencing and recording server 104, at least one video post processing server 106 and at least one notification server 108. The system 100 includes a video storage database 114 and a database 116. The web based video interviewing system 100 provides a platform for online interaction of at least two persons via communication devices such as a mobile device based user 110 or a desktop computer based user 112. The database 114 is configured to store information of the pre-recorded interaction. The video post processing server 106 is configured to receive new task descriptions from a video processing message queue 107 on a periodic basis. The notification server 108 is configured to accept new task descriptions from a notification processing message queue 109 on a periodic basis.

In accordance with the present invention, the users 110, 112 connect to the web server 102 by using their login credentials. The users 110, 112 login to the system by various modes such as by entering their login credentials, by social networking site such as Facebook, Linkedin and the like. The user interacts with the system based on his role to use the system such as an interviewer or an interviewee or an employer. The users 110,112 may upload the information of their interest on the web server 102 either in word format or in the form of video or by accessing a registration form available on the system 100.

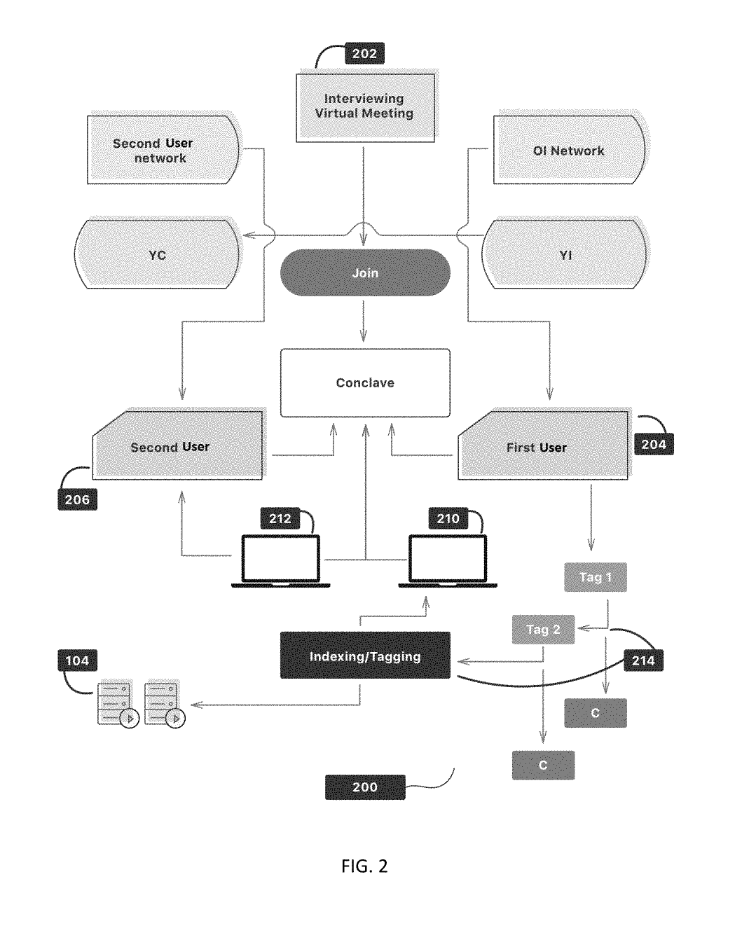

Now referring to FIG. 2, a schematic block diagram of the system 200 is shown. The registered user may access system 100 as an interviewer, an interviewee or an employer. In accordance with the preferred embodiment of the present invention, the interviewer is a first user 204, the interviewee is a second user 206 and the employer is a third user (not shown).

The first user 204 and the second user 206 upload their information on the web server by accessing a registration form available on the web server 102. The users 204,206 upload their information regarding their education, skills, preferred work location, work experience, projects and achievement and the like by selecting options from drag down boxes or in text format using similar means. The users may also give rating to his/her skills uploaded on the server. The first and second users 204, 206 may also upload their information thereby uploading their resume in formats such as .doc, .pdf, .jpg and the like. The first and second user 204, 206 may also upload their information by recording an introduction video. It is understood here that, the introduction video is a recorded video of predefined time duration having additional information other than that of disclosed in the resume or registration form. The third user preferably uploads information related to the required skills of the candidate or job description in standardized format.

The information uploaded by the first user 204, the second user 206 and the third user is stored in the database 116 that is accessible by the web based video interviewing system 100.

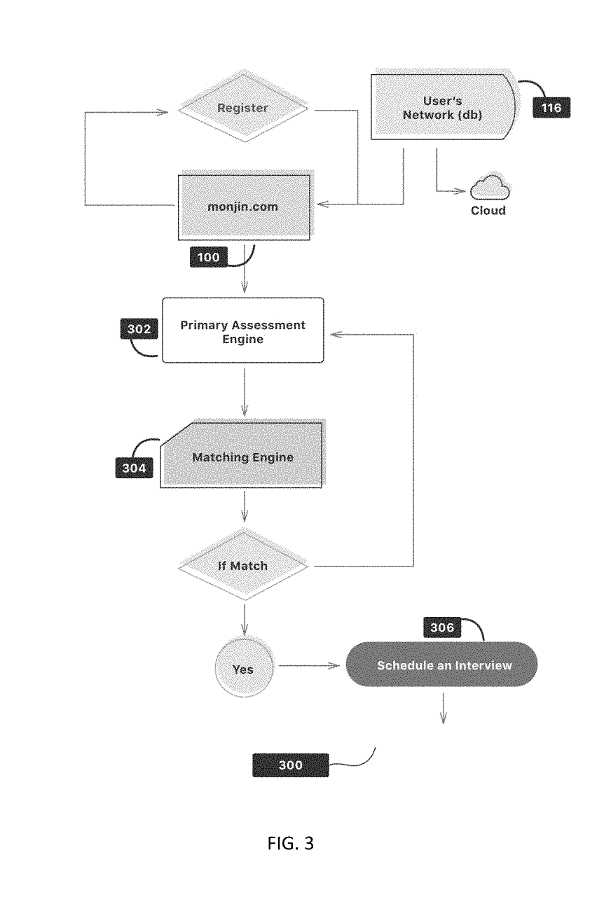

As shown in FIGS. 2-3, the information uploaded by the first user 204, the second user 206 is sent to a primary assessment engine 302 of the system 100. The primary assessment engine 302 assesses and verifies the proficiency of the first user 204, the second user 206 on the basis of received information. After verification, the assessed information is sent to a matching engine 304. The matching engine 304 matches and classifies the information provided by the first user 204 and second user 206. After matching the information uploaded by the first and second users 204, 206 the matching engine 304 establishes a link, provided that the information provided by the first user and the second user 204, 206 are found relevant and matching.

In accordance with the present invention, the signals received from the matching engine 304 are sent to a scheduling engine 306. The scheduling engine 306 allows the first user 204 and the second user 206 to mark slots for interview as per their availability. The scheduling engine 306 facilitates auto matching of the slots confirmed by the first and second users 204, 206 and sends information thereof to a notification server 108 (Refer FIG. 1). The notification server 108 sends alerts about details of slots to the first user and second users 204, 206 accordingly.

Referring back to FIG. 2, the scheduling engine 306 sends details of the scheduled interview to a video interviewing engine 202. The video interviewing engine 202 facilitates the first and second users 204, 206 to interact online with a cloud based storage infrastructure. The interview is conducted on receiving positive signals from both the users 204, 206. The interview is conducted by the first user 204 via audio-visual electronic mediums 210,212 such as a personal computer. The computer system 212 used by the first user 204 has an automated provision for tagging relevant sections 214 during the interview. The relevant sections 214 are tagged on basis of matching the information required by the first user 204 and the information provided by the second user 206. The first user 204 can also create new tag information to be used during the interaction.

The audio-visual electronic medium 210 used by the first user 204 has a provision of rating the conversation at relevant sections. The first user 204 rates the conversation at the recorded interview with a plurality of tags at relevant section, that is saved and sent to the video conference and webservers 102 (Refer FIG. 1). The first user 204 rates the second user 206 on the basis of his/her performance during their audio-visual interview.

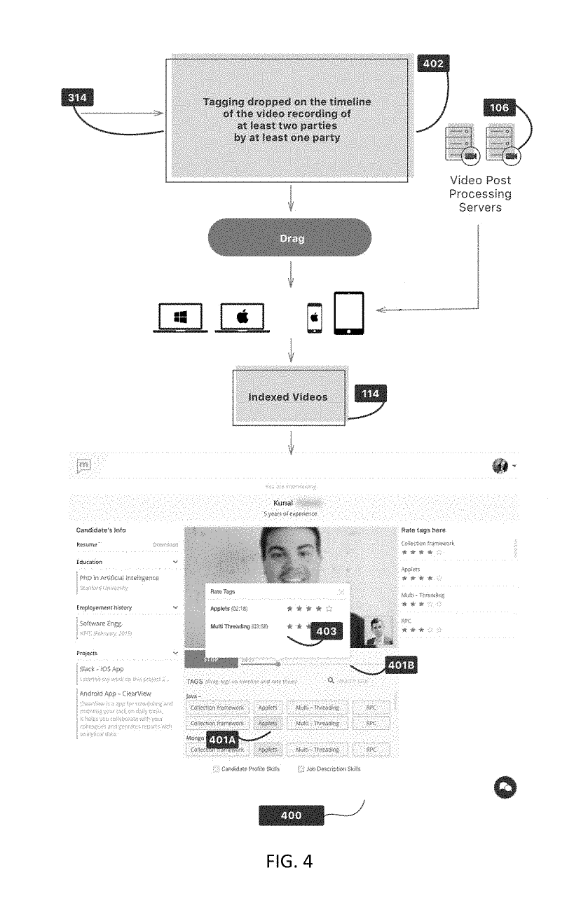

Referring to FIG. 4, in accordance with tagging and rating relevant sections during interviewing 402, the first user 204 may drag and drop a tag 401A at a desired time. A marker 401B such as a dot appears on the timeline when the tag 401A is inserted. A star rating scale 403 can be viewed and accessed on clicking on the marker 401B. A consolidated view of all the tags 401A can be viewed at the end of the interview. Accordingly, a final assessment form is generated which indicates rating 403 and exact elapsed time of tagged sections 401A from start of the interview.

With reference to relevant sections 214 (Refer FIG. 2), the tags 401A are auto generated in the web based video interviewing system 100 OR can be created by user 204 based on uploaded information by the users 206, 204. The recorded tagged videos are accessible to the third user via web servers 102.

The video conference and recording servers 104 are used for runtime provisioning of video conference, keeping track of participants and recording the interview session. The video post processing servers 106 receives new task descriptions from video processing message queue 107 on a periodic basis and post processes the video. On successful completion of the post processing, the video is made available on video storage database 114. On failure of the process, a log of the incidence is maintained and alert is sent to maintenance team accordingly. The notification servers 108 accept new task descriptions from the notification processing message queue 109 on a periodic basis. On successful acceptance of a task the notification servers 108 send the alert of the mentioned event to corresponding users 204, 206. The database 116 stores all the user records such as user profiles, interviews, tags inserted by the first user 204 during interview sessions, assessment.

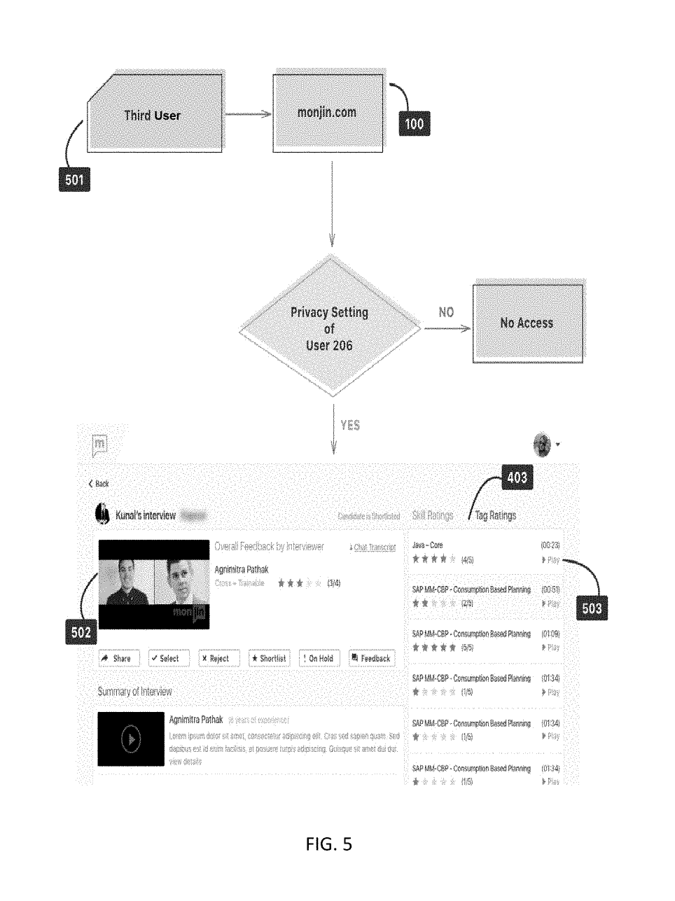

As shown in FIG. 5, the third user 501 logs on to the system 100 and in accordance with privacy settings of the second user 206, to get selective access to the video recording and related assessment. In case of a positive outcome, the interview video with all the assessment information created by user 204 including star ratings, tags and subjective feedback is available to the third user 501. The third user 501 can then playback the video 502 in its complete form or can chose to play only relevant sections of the video by clicking on the playback markers 503 shown along with tags 403 created by the user 206.

In an embodiment of the present invention an employer acting as the third user uploads a job description or required skill set in a standardized format provided by the web servers 102. Similarly, a candidate acting as the second user 206 uploads her resume or video recording or registration form in a standardized format provided by the web servers 102. The web based video interviewing system 100 facilitates the interviewer to generate a plurality of tags 401A based on information retrieved from the employer and the candidate during the interview. On the basis of the generated tags the web based video interviewing system 100 executes indexing and rating of the recorded video of the interview session. The tagging of relevant sections 214 highlights the start of discussion on points of interest.

The interviewer generates final assessment report having a summary video and star rating. The summary video includes the interviewer's recommendation about the candidate. The interviewer also gives star rating to an interviewee on the basis of his/her performance.

The pre-recorded interview videos in accordance with the present invention are made available to the employers according to their request. The employers have access to the profiles uploaded by the candidates and the interviewer and prerecorded videos by the interviewer according to their privacy settings. The employers may also invite candidates and conduct interviews on their own without involving the interviewers. The interviewees may block the employers of their choice such that the interviewees become invisible to the blocked employers in their search results.

Referring to FIGS. 1-5, the web based video interviewing system 100 having an inbuilt network for online interaction of at least two users 204, 206 by matching their interests. The web server 102 provides access to the various functionalities such as profile data entry, scheduling of interviews, conducting interviews, watching the interview video files online among others to authenticated users. It is understood here that the mobile users 110 may access the web server 102 via native app or browser available on the respective operating system and the desktop users 112 may connect to the web server 102 via installed web browser, the operating system with a browser supporting WebRTC and hardware access to camera and microphone is supported.

The web based video interviewing system 100 of the present invention provides platform for online interaction for at least two users according to their availability. The system 100 eliminates the need to visit different organizations or people that saves time and money spent on the same. The system 100 is a user friendly system that facilitates the users to directly access or view tagged sections 214 while evaluating the interview by registering authentically.

The embodiments of the invention shown and discussed herein are merely illustrative of modes of application of the present invention. Reference to details in this discussion is not intended to limit the scope of the claims to these details, or to the figures used to illustrate the invention.

It is understood that various omission and substitutions of equivalents are contemplated as circumstance may suggest or render expedient, but such are intended to cover the application or implementation without departing from the spirit or scope of the present invention.

1. A system for indexing, tagging and video interviewing, the system comprising:
a web server facilitating uploading of a predefined information of a first registered user, a second registered user and a third user;
a database storing the predefined information uploaded on the web server;
a primary assessment engine assessing the predefined so information of the first user and the second user;
a matching engine communicating with the primary assessment engine for matching and classifying the information of the first user with the second user thereby establishing a connection therebetween;
a scheduling engine communicating with the matching engine for receiving conforming and sending the connection details thereby to a notification server; and
a video interviewing engine communicating with the scheduling engine, the video interviewing engine having a video conferencing and recording server, a video storage database and a video post processing server, the video conferencing and recording server facilitating insertion of at least one tag along with indexing and rating of an audio-visual interview through a marker, the video storage database storing the audio-visual interview, the video post processing server processing stored audio-visual interview thereby generating a final assessment form having has rating and exact elapsed time of tagged sections, the final assessment form being accessible to the third registered user.

2. The system as claimed in claim 1, wherein the marker facilitates assessment of a star rating scale.

3. The system as claimed in claim 1, wherein the predefined information includes user profile records, audio-visual interaction and tags inserted by the first user.

4. The system as claimed in claim 3, wherein the user profile records are uploaded on the web server in a form selected from a video, a resume and a registration form.

5. The system as claimed in claim 1, wherein the web server facilitates playback of the video to play the relevant sections of the video thereby clicking on at least one playback marker.

6. A method for an indexing, tagging and video interviewing, the method comprising the steps of:
receiving a predefined information uploaded by a first user and a second user on a web server via a plurality of communication devices;
forwarding the predefined information for assessing proficiency thereof;
matching the predefined information of the first user with the predefined information of the second user;
allotting a time slot for an audio-visual interview to the first user and the second user corresponding to the matched information thereof;
sending alerts to the first user and the second user regarding allotted time slot;
establishing a link for the audio-visual interview per the allotted time slot;
tagging, indexing and rating the audio-visual interview for a desired time by the first user;
recording and storing sessions of the audio-visual interview;
generating a final assessment form; and
making the pre-recorded sessions available to a registered third user thereby utilizing the tags for reviewing specific sections of the audio-visual interview.
